(19) United States
(12) Patent Application Publication
(10) Pub. No.: US 2006/0218480 A1
(43) Pub. Date: Sep. 28, 2006

(54) Data output method and system

(76) Inventors: Guido Moggert, Kaiserslautern (DE); Michael Neidhofer, Hochspeyer (DE); Martin Suss, Kaiserslautern (DE); Christian Reitz, Kaiserslautern (DE)

Correspondence Address: ARENT FOX PLLC, 1050 CONNECTICUT AVENUE, N.W., SUITE 400, WASHINGTON, DC, 20036, US

(21) Appl. No.: 11/346,365

(22) Filed: Feb. 3, 2006

(30) Foreign Application Priority Data
Mar. 23, 2005 (DE) 10 2005 013639.7

(51) Int. Cl. G06F 17/00

(52) U.S. Cl. 715/500

(57) ABSTRACT

A method and system for outputting data to be viewed on a mobile terminal or other device that has requested the data to be displayed from a data provider. This outputting of viewable data includes: 1) identifying the system parameters of the terminal by a) querying the equipment identification code of the terminal, b) determining from a database the relevant system parameters (e.g., available memory space, displayable character sets, resolution of the display, depth of color, Codec capabilities, video and audio bit rates, streaming capability; 2) converting the data to be displayed and maintained in a terminal-independent data format, into a terminal-dependent data format by selecting a predefined transformation protocol that corresponds to the system parameters of the terminal; 3) executing the transformation of the data to be displayed in accordance with that transformation protocol; and 4) transferring the data to the terminal.

This application claims priority to German Patent Application No. 10 2005 013 639.7, filed Mar. 23, 2005, the entirety of which is incorporated herein by reference.

### BACKGROUND OF THE INVENTION

1. Field of the Invention

This invention relates to a method and a system for outputting data to be viewed, and particularly to outputting viewable data on a mobile terminal that has requested the data to be displayed from a data provider (e.g., via a particular Internet portal).

2. Background of the Technology

Given modern communication capabilities, especially in the realm of mobile telephony, it is becoming increasingly possible to view complex data contents, especially from the Web, on mobile terminals, such as cellular telephones, organizers and the like. However, the data provided through the Internet are mostly so voluminous and tailored to the high performance of modern web browsers, that a direct display of the information is usually not possible on mobile terminals. Typically, these mobile terminals have a small display screen offering only limited resolution and color depth. Equally limited are transfer rates and input capabilities for these terminals. It is therefore common practice to convert information provided over the Internet in the form of text, image, video and/or audio data and intended for display on a mobile terminal, into a data format compatible with the terminal concerned.

One such method is described, for example, in WO02/059790 A1, according to which a terminal will request specific application-related data via a so-called Internet portal. The portal identifies the requesting terminal, then routes the request of that terminal to the appropriate application, which, in turn, provides the requested information in a first data format, referred to as markup language and containing links to the actual data content. In a first step for adapting the data content, the links of the markup language are compiled into fixed links or direct data files, followed by a second conversion step, in which the data to be furnished are converted into a data format adapted to the terminal concerned. This conversion step is accomplished by means of a so-called transformation style sheet that constitutes a fixed protocol, on the basis of which the data are converted from the original markup-language format into the terminal-compatible data format. One drawback here, however, is that for every terminal, a specific transformation style sheet must be pre-established, making portal management and the addition of new terminals a complex task.

### SUMMARY OF THE INVENTION

One advantage of the present invention is to introduce a method for converting data of the type described above for display on a terminal, permitting flexible adaptation of the output data to such terminal.

According to the invention, this capability is achieved by an optimizing step, in which 1) data that have already been converted into the terminal-dependent data format are adapted; and, 2) after adaptation, the data are transferred to the terminal, having specific system properties for that terminal, as derived from the system identification code of the terminal. This two-step conversion process permits easy and flexible adaptation of the data, transmitted for display to specific individual terminals, by utilizing basic data-format conversion performed via the transformation protocol into a terminal-compatible data format, as the starting point for optimized adaptation to the specific characteristics of the terminal concerned. For that optimizing step, it is possible to specify a controller design based on typical terminal parameters, such as memory capacity, displayable character sets, display screen resolution, color depth, Codec capabilities, streaming capabilities and bit-rate limitations, allowing for automated optimization.

Adding a new terminal for similar adaptation and transfer thus merely requires correlating the system parameters of the terminal with the new equipment identification code, and storing this data, for instance, in a repository, such as a database. According to the present invention, it is thus not necessary to create a complete, new transformation protocol for the terminal that would convert the target data into a terminal-dependent data format. Therefore, compared to prior-art methodology, the present invention permits simpler, more flexible manipulation, while reducing the development effort for the addition of new terminals. In addition, the controller itself can be of a configurable design.

According to one implementation of the present invention, the optimizing step permits distribution of the data over several document pages, depending on the available memory space (e.g., the storage capacity per document page). In this case the document page is so dimensioned that in terms of memory capacity and the size and resolution of the terminal display screen, the distributed data for a page can be displayed as one complete image. This optimized preparation of the data to be displayed permits a centrally specified and implemented appearance of the data set, so that configuration instructions for data preparation can be contained in the controller for the optimizing step. Automated distribution is possible for instance through the recognition of control characters within the converted data, which predefine preferred break points. These control characters can be configured in a markup language in which the data to be displayed are made available in a terminal-independent data format. The control characters are appropriately mapped during the conversion into a target markup language. Apart from the storage capacity of the document page in the terminal, the distribution of the documents over several pages may also take into account the load time of a page, allowing for rapid display of the data on the terminal. Specifically, the first data page can be transferred while the optimization and transmission of the subsequent data pages are still in progress. It follows that, in practical application, the user of the terminal does not have to contend with long delays.

During the process of distribution of the data to be displayed over several document pages, it is possible to insert on one document page navigation elements for accessing the individual document pages of the overall document. These navigation elements can include buttons on a touch screen, menus or page numbers, or a slide-show or video playback function, each of which is selectable, for example, via specific function keys.

According to the invention, characters embedded in the data for the optimizing step are checked for displayability and, where appropriate, are converted into a format displayable on the terminal. This checking is important especially in connection with text characters that are transmitted as the code number of a character set, if and when the text contains language-related special characters, for example. Depending on how the terminal is configured, these characters may or may not be displayed correctly. Prior verification of the displayability of these characters in a text that is to be displayed on the terminal can therefore determine whether they will appear correctly. Alternatively, it is possible to convert the character concerned or the entire text, for example, into a graphic character format to permit a correct readout. The same applies to the display of image, video, and audio data, for which a check may be made of the correct displayability on the terminal for information contained in the data set, thus allowing for a correction of the information in the event that errors are expected. If such corrections are made during the setup or operating phase of a system, the corrections are preferably stored as part of the terminal's system parameters. To permit easy adaptation to new equipment, the system parameters of a terminal may be entered, for instance, as updates in systems installed earlier, thereby enabling these systems to employ the novel method.

Quick, smooth conversion and optimization can be achieved in the optimizing step by the parallel processing of text, image, video, and/or audio data contained in the data set. This approach is particularly advantageous for large data volumes, as in the case of video and audio files, which, if using a demultiplexing process, for example, can be broken down and processed as different data sets.

To optimize the screen image, the invention provides the particularly desirable ability to combine the image and/or text data contained in the file to be displayed into a new composite graphic that can be converted into the preferred graphic format for the terminal concerned. By creating such an image, in an image generator, for example, many different information elements in different data formats may be compounded into a uniform data format that is easier to optimize and usually involves a smaller data volume. In particular, it is possible for each document page (e.g., covering the entire available display area of the terminal) to be individually generated as a self-contained image that is easily scalable and adaptable in its entirety with unchanging quality.

For maximum attainable utilization of the configurability of the terminal, the optimizing step of the present invention allows, by means of an iterative process, adaptation of the resulting data display to the available memory space, the display resolution and color depth, the Codec capabilities, and/or existing video/audio bit-rate limitations. This process can be accomplished by first generating an optimal image, in terms of its visual appearance (e.g., involving image size, display resolution, color depth), and then testing the image size or other limitations (e.g., load time, optimized Codec image format such as JPEG, GIF, PNG, WBMP) of the terminal. This process is repeated by scaling individual parameters, until the size of the image optimally utilizes the available memory space. In this context, the individual parameters are specifically weighted so as to allow for an evaluation of the optimum display quality.

In one embodiment of the above-described iterative procedure, the present invention provides for the parallel preprocessing of the data converted for several iterative steps in the optimization process, and staging in a buffer memory corresponding to the subsequent iterative steps. To the extent that these iterative steps are needed, the data is made available for immediate verification without first having to be generated. If the iteration is aborted, the data is simply discarded.

The present invention also relates to a system for outputting data to be displayed, particularly on a mobile terminal, according to the characterizing features specified below, as appropriate for implementing the method described above. The system includes a terminal identification unit and a controller, with the latter, in one embodiment, incorporating a converter for the conversion of the target data maintained in a terminal-independent data format into a terminal-dependent data format. According to one embodiment, the converter includes a series-connected post-processor that serves to adapt the data, converted into the terminal-dependent data format, to specific system characteristics of the terminal concerned. The separation of the original conversion into a data format that is basically displayable on the terminal, from a subsequent optimization of that data format for the requirements of a specific type of terminal, allows flexible conversion of the data being displayed to various types of terminals. It is also possible to perform the basic conversion once and store this information in a repository (e.g., a database), if subsequent requests from several similar terminals can be expected. Via this approach, the processing speed can be further increased.

According to one embodiment of the present invention, the post processor is equipped with size partitioning units specifically serving to adjust textual information contained in the data set being displayed, so as to allow the processor to generate images, convert images, and convert video and/or audio data, to the extent that these have been processed for the implementation steps of the method described above.

To increase processing speed, in one embodiment, at least two units of the post processor are able to operate in parallel, with their results combined in the parent post processor or in the converter, from which the controller transmits these results to the terminal.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURE

In the drawings:

FIG. 1 presents a representative diagram of a system and functionality for providing display for a mobile terminal, in accordance with an embodiment of the present invention.

### DETAILED DESCRIPTION

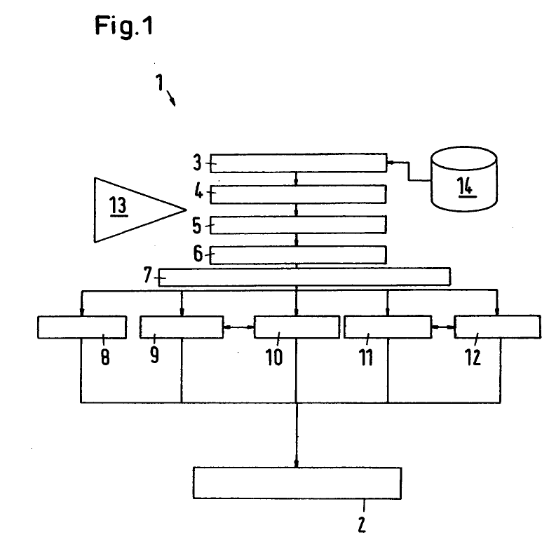

FIG. 1 contains a schematic depiction, in a functional flow diagram, of a system 1 serving to output data for display on a mobile terminal 2 (e.g., a cellular telephone) featuring a terminal identification unit 3 and a controller 4. Specifically, as shown in FIG. 1, the system 1 may be incorporated in a single processor or, in distributed fashion, across several processors of a data processing unit equipped with appropriate interfaces to a communication network, such as the Internet.

Integrated in the controller 4 are a preprocessor 5, a converter 6 that serves to convert display data maintained in a terminal-independent data format into a terminal-dependent data format, and a post processor 7 designed to adapt the data that have been converted into the terminal-dependent data format to specific system characteristics of the terminal 2. To that effect, the post processor 7 incorporates a unit 8 for size partitioning and text conversion, a unit 9 for image generation, a unit 10 for image conversion, a unit 11 for video conversion, and a unit 12 for audio conversion. Each of these units work in parallel and are partly capable of a mutual data exchange, in the embodiment shown in FIG. 1. The post processor 7 serves to optimize the data that have been converted by the converter 6 into a terminal-readable data format, with regard to the specific system parameters of the mobile terminal 2 to which the data to be displayed are sent, upon completion of the conversion, by the controller 4, which controls the overall conversion process.

The system 1 receives the data to be displayed in a terminal-independent data format via a connector 13 that downloads these data, such as from certain applications on the Internet.

The system 1 is designed to recognize mobile terminals 2, upon requests being transmitted to computer systems, and to control the output function for the mobile terminals 2 in a manner whereby any content provided via the connector 13 for output to the mobile terminals 2 is delivered in an optimally adapted format for the requirements of the mobile terminals 2. The content to be displayed may include data in various media formats, such as text, images, graphics, photos, videos, sounds, or other applications. The mobile terminals 2 may include cellular telephones, smartphones, personal data assistants (PDAs), mobile development environment (MDE) devices, virtual-reality goggles, and head-up displays, as well as other terminals 2 having display and data transfer modules. The system 1 may also be used in conjunction with non-mobile terminals 2.

The following implementation example will describe the conversion method i of an exemplary implementation of the present invention, with reference to FIG. 1. In FIG. 1, a terminal 2 transmits a request (not indicated in FIG. 1) polling a given communications network, such as the Internet, for certain data. The request, specifying the desired information and containing an equipment identification code, is transmitted from the terminal 2 to a central server. The central server collects the requested data and transmits these collected data to the system 1 via the connector 13, in a terminal-independent data format. The system 1 may even be directly integrated into the data server, so that the request is transmitted straight from the terminal 2 to the system 1, which, in turn, requests the desired data from another server via the connector 13. In that case, the system 1 operates as so-called “middleware” between the requesting terminal 2 and a back-end server that provides the requested data in a terminal-independent data format (e.g., in a general markup language).

Alternatively, the Web server can preprocess the request of the terminal 2 and then route the desired information to a back-end server on which the system 1 is implemented. Accordingly, the system according to this embodiment of the present invention can be used as a front-end, as well as a back-end system.

Initialization of the system is triggered by a request, which is followed by a prompt querying the equipment identification code of the requesting terminal 2. The equipment identification code reveals the system parameters of the terminal 2. In one embodiment, the system 1 contains a repository 14, such as a database, that stores the system parameter information associated with the equipment identification code for the terminal 2.

The equipment identification code preferably includes various elements of data, such as the manufacturer's name, equipment model, and firmware version. When the equipment identification of the requesting terminal 2 matches a data set in the system parameters stored in the repository 14, specific control characteristics of the mobile terminal 2 will be forwarded to the controller 4 for further processing. If an incomplete match occurs between the equipment identification code and a data set stored in the repository 14, a search is conducted for the closest possible system information. That search will first be aimed at the parameters of an older model of the same equipment by the same manufacturer, for example. If no similar model can be found, the parameters of the technically simplest device will be selected for executing the data conversion. This approach makes it possible for the system 1 to work even with new equipment that has not yet been specified in the repository 14.

The system parameters of the terminal 2 include, for example, the available memory space, the accessible character sets within the boundaries of the character coding used, the display resolution, the displayable color depth, Codec capabilities (e.g., the ability to display descriptive data formats, the number of displayable images per second, streaming capabilities) and any potential video/audio bit-rate limitations. These system parameters of the terminal 2 are transferred to the controller 4 for further processing. The controller 4 coordinates the subsequent progression of the conversion process, storing intermediate conversion results in a buffer memory for facilitated availability. This buffered storage includes, for example, the data provided for display via the connector 13 in a terminal-independent data format (e.g., the data format in which the data are accessed on the Internet). These data may include Hypertext Markup Language (HTML) data, which, while directly displayable with an Internet browser, typically cannot be displayed on mobile terminals. In other words, the data are supplied in a terminal-independent data format.

For further processing, the controller 4 routes the data to be displayed, along with the system parameters, to a preprocessor 5, in which the data to be displayed are preprocessed such that, with the aid of control signals provided by the requesting terminal 2, the raw data supplied may be analyzed and internally prepared for the subsequent conversion steps. At that juncture, certain initial terminal-dependent data conversions may already be possible, in the form of control-character insertions into the raw data. Preferably, however, only those conversions are made in this phase of the process that apply to a wide range of possible terminals 2. The data preprocessed up to this point are cached and routed to the converter 6, where the data that have been prepared in the preprocessor 5 are transformed into the desired terminal-dependent data format (e.g., target markup language, such as wireless markup language (WML), extensible hypertext markup language (XHTML), compact hypertext markup language (CHTML), Vodafone ML, and linked with optimized contents and terminal-specific control commands for the mobile terminal 2. The conversion takes place by means of a predefined transformation protocol, such as an extensible stylesheet language transformations (XSLT) selected to correspond to the system parameters of the terminal 2. After that transformation, the data are in a terminal-dependent data format and can essentially be output to any terminal 2 that supports this data format.

The data delivered by the converter (render engine) can in essence be displayed on numerous types of equipment and are not completely adapted to a specific type of equipment. It is therefore desirable to stage the data in intermediate storage for similar requests by other terminals 2 of a comparable type.

Following this basic conversion, the data are transferred to a post processor 7, which is designed to adapt the data set emanating from the converter 6 and including the entire content, for the specific terminal 2, at the highest possible quality. That post processor 7 processes text, still images, video, image sequences and/or sound. To this end, the post processor 7 is provided with a control program that defines the manner in which display data delivered in a terminal-dependent data format can be adapted to specific terminal-system parameters, and thus optimized. This control program procedure involves a progression through different optimizing steps, individually mapped to discrete units and executed in parallel, and, where appropriate, mutually interlinked.

In line with the document-page storage capacity of a terminal 2, a size-partitioning and text-converting unit 8 performs a size optimizing function. As a result, where necessary, a relatively large document is partitioned and distributed over several document pages for consecutive display. In terms of both available memory space and display resolution, each such page is of a size that permits it to be displayed as a full screen image on the terminal. The page being displayed additionally contains navigating elements that permit switching among the pages. This function is also implementable as an automatically generated image sequence.

The size-partitioning unit 8 also converts text by transforming special characters into a format that the requesting terminal 2 can read (e.g., it replaces special characters with entities specifically coded for the terminal 2). In this case, a character-set code may be used for the text.

In addition, in embodiments of the present invention, it is possible to combine in an image generator 9 textual and/or image data to produce a new, uniform graphic that is composed and readied for display based on the equipment-specific system parameters and control signals for the terminal 2, with regard to pixel size and maximum attainable color depth. Both the image and text information in the newly created graphic are distributed and positioned in legible fashion. This result can be technically achieved by means of evaluation factors assigned to the individual elements and scaled together with pictorial and textual elements. Embodiments of the present invention also take into account the available Codec image formats. The graphic thus generated is then passed on to the image converter 10, in which either this graphic or an externally provided graphic is iteratively optimized, until the available memory space is maximally utilized for the best possible image quality.

To that end, a visually optimal image is created first, after which the size of the image is reviewed with due consideration of other limitations, such as load time or the Codec image format. By scaling individual parameters, this process is repeated until the storage size of the image makes maximum use of the available memory space of the terminal 2. The individual parameters are weighted to allow defining of the sequence of the iteration.

A similar approach is taken for the video converter 11 and the audioconverter 12, which must make allowances not only for the image-processing aspects, but, additionally, for the number of image frames displayable per second, the streaming capabilities, and the video/audio bit-rate limitations. For example, to maintain the number of image frames displayable per second, it is possible for the raw video sequences to be cut at periodic intervals. A substantial reduction in storage-space requirements—and thus an accelerated frame rate—can thereby be realized at the expense of resolution.

In addition, the source video may be split into two tracks (e.g., a video and an audio channel), which will ultimately be recombined at the time of display on the terminal.

The processes taking place in the post processor 7 are executed in parallel and are combined by the controller 4 before the data to be displayed are transferred, as a data set, to the terminal 2.Accordingly, the system 1 and method of the present invention make it possible to obtain an optimized data output to any given terminal 2, executable without a time delay and easily adaptable to different terminals 2, since the data conversion into a terminal-dependent data format and the optimization for a specific terminal are carried out in two consecutive processes.

Although exemplary embodiments of the present invention have now been discussed in accordance with the above advantages, it will be appreciated by one of ordinary skill in the art that these examples are merely illustrative of the invention and that numerous variations and/or modifications may be made without departing from the spirit or scope invention.

### Appendix

### List of Reference Numbers

1 Data output system
2 Mobile terminal, cell phone
3 Terminal identification unit
4 Controller
5 Preprocessor
6 Converter
7 Post processor
8 Size partitioning and text converting unit
9 Image generator
10 Image converter
11 Video converter
12 Audio converter
13 Connector
14 Database

1. A method for outputting data to be displayed on a terminal requesting display, the terminal having terminal-specific display limitations, the method comprising:
identifying the system parameters of the terminal by querying an equipment identification code for the terminal;
maintaining the data to be displayed in a terminal-independent data format;
converting the data from the terminal-independent data format into a terminal-dependent data format by selecting a predefined transformation protocol based on the identified system parameters of the terminal;
transforming the data in the terminal-dependent data format using the selected transformation protocol,
adapting the transformed data in the terminal-dependent data format based on equipment-specific characteristics of the terminal, wherein the equipment-specific characteristics of the terminal are determined by the system parameters of the terminal; and
transmitting the transfomed and adapted data in a terminal-dependent data format to the terminal.

2. The method of claim 1, wherein, variably depending on the available storage space and the memory capacity per document page, adapting the transformed data in the terminal-dependent data format includes:
providing for the distribution of the transformed data over a plurality of document pages.

3. The method of claim 2, further comprising:
inserting navigating elements in each document page, the navigating elements permitting the call-up of document pages.

4. The method of claim 1, wherein adapting the transformed data in the terminal-dependent data format includes:
analyzing characters contained in the data for displayability; and
converting the characters into a format displayable on the terminal.

5. The method of claim 1, wherein the transformed data in the terminal-dependent data format includes data elements, and wherein adapting the transformed data in the terminal-dependent data format includes:
processing the data elements in parallel.

6. The method of claim 5, wherein the data elements include at least one selected from a group consisting of text data, image data, video data, and audio data.

7. The method of claim 5, wherein adapting the transformed data in the terminal-dependent data format includes:
combining the data elements into a graphic.

8. The method of claim 1, wherein adapting the transformed data in the terminal-dependent data format includes:
iteratively adapting the transformed data in the terminal-dependent data format to display limitations of the terminal.

9. The method of claim 8, wherein the display limitations of the terminal include at least one selected from a group consisting of available storage space, display resolution, color depth, Codec capabilities, and video/audio bit-rate limitations.

10. The method of claim 8, wherein the iteratively adapted data are preprocessed in parallel and intermediately saved.

11. The method of claim 10, wherein the iteratively adapted data are stored in a repository.

12. The method of claim 1, wherein the terminal is a mobile device.

13. A system for outputting data to be displayed on a terminal having terminal-specific display limitations, the system including:
a terminal identification unit;
a controller, the controller including:
a converter for converting the data to be displayed that are available in a terminal-independent data format into a terminal-dependent data format; and
a post processor connected in series with the converter for adapting the converted data to a data format specific to requirements of the terminal;
wherein the system parameters of the terminal are identified by querying an equipment identification code for the terminal;
wherein the data to be displayed in a terminal-independent data format are maintained;
wherein the data are converted from the terminal-independent data format into a terminal-dependent data format by selecting a predefined transformation protocol based on the identified system parameters of the terminal;
wherein the data in the terminal-dependent data format are transformed using the selected transformation protocol,
wherein the transformed data in the terminal-dependent data format are adapted based on equipment-specific characteristics of the terminal, wherein the equipment-specific characteristics of the terminal are determined by the system parameters of the terminal; and
wherein the transfomed and adapted data in a terminal-dependent data format are transmitted to the terminal.

14. The system of claim 13, wherein the terminal is a mobile device.

15. The system of claim 13, wherein the post processor includes:
components for at least one of size partitioning, image generation, image conversion, video conversion, and audio conversion.

16. The system of claim 15, wherein at least two of the components are processed in parallel.
